(19) United States
(12) Patent Application Publication
(10) Pub. No.: US 2026/0072208 A1
(43) Pub. Date: Mar. 12, 2026

(54) ACTUATABLE OPTICAL WAVEGUIDE

(71) Applicant: Toyota Motor Engineering & Manufacturing North America, Inc., Plano, TX (US)

(72) Inventors: Yuyang Song, Ann Arbor, MI (US); Mingzhe Li, Atlanta, GA (US); Shinnosuke Shimokawa, Ann Arbor, MI (US); Hang Qi, Marietta, GA (US)

(73) Assignees: Toyota Motor Engineering & Manufacturing North America, Inc., Plano, TX (US); Toyota Jidosha Kabushiki Kaisha, Toyota-shi Aichi-ken (JP); Georgia Tech Research Corporation, Atlanta, GA (US)

(21) Appl. No.: 18/828,248

(22) Filed: Sep. 9, 2024

(51) Int. Cl. G02B 6/02; G02B 6/036; G02B 6/35

(52) U.S. Cl. CPC G02B 6/02033; G02B 6/03694; G02B 6/3576

(57) ABSTRACT

An actuatable optical waveguide includes an optical fiber with a liquid crystal elastomer (LCE) outer cladding, a polymer core disposed within the outer cladding, and a shape memory polymer (SMP) layer disposed on an outer surface of the outer cladding such that the optical fiber is configured to reversibly change shape upon actuation of the SMP layer. In some variations, the LCE outer cladding is a UV-cured LCE outer cladding, the polymer core is a UV-cured polydimethylsiloxane (PDMS) core, and the SMP layer is a UV-cured SMP layer.

### TECHNICAL FIELD

The present disclosure relates generally to optical waveguides.

### BACKGROUND

Optical waveguides, such as optical fibers, control and direct light within various devices and systems such that signals are transmitted over large distances. And optical fibers generally include and outer cladding and a core that allows for propagation of light from an attached light source to a receiving device.

The present disclosure addresses issues related to optical fibers and other issues related to optical waveguides.

### SUMMARY

This section provides a general summary of the disclosure and is not a comprehensive disclosure of its full scope or all of its features.

In one form of the present disclosure, an actuatable optical waveguide includes an optical fiber with a liquid crystal elastomer (LCE) outer cladding, a polymer core material disposed within the outer cladding, and a shape memory polymer (SMP) layer disposed on an outer surface of the outer cladding such that the optical fiber is configured to reversibly change shape upon actuation of the SMP layer.

In another form of the present disclosure, an actuatable optical waveguide includes an optical fiber with a UV-cured LCE outer cladding, a UV-cured polydimethylsiloxane (PDMS) core material disposed within the UV-cured outer cladding, and a UV-cured SMP layer disposed on an outer surface of the outer cladding such that the optical fiber is configured to reversibly change shape upon actuation of the UV-cured SMP layer.

In still another form of the present disclosure, an actuatable optical waveguide includes an optical fiber with a UV-cured LCE outer cladding, a UV-cured PDMS core material disposed within the UV-cured LCE outer cladding, and a UV-cured SMP layer disposed on a circumferential portion of an outer surface of the outer cladding, the circumferential portion of the outer surface being less than an entirety of the outer surface, such that the optical fiber is configured to reversibly change shape upon actuation of the UV-cured SMP layer.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1A is a perspective view of an actuatable optical waveguide according to one form of the present disclosure;

FIG. 1B is an end view of the actuatable optical waveguide in FIG. 1A;

FIG. 1C is a side cross-sectional view of section 1C-1C in FIG. 1B;

FIG. 2A illustrates the actuatable optical waveguide in FIGS. 1A-1C at initiation of actuation (t=tₒ);

FIG. 2B illustrates the actuatable optical waveguide in FIG. 2A after actuation (t=t₁);

FIG. 2C illustrates the actuatable optical waveguide in FIG. 2A after further actuation (t=t₂);

FIG. 3 is a graphical plot of bending angle as a function of temperature for an actuatable optical waveguide according to the teachings of the present disclosure;

FIG. 4 is a graphical plot of attenuation as a function of Fober length for an actuatable optical waveguide according to the teachings of the present disclosure;

FIG. 5A is an end view of an actuatable optical waveguide according to another form of the present disclosure;

FIG. 5B is a side cross-sectional view of section 5B-5B in FIG. 5A;

FIG. 6A illustrates actuation of the actuatable optical waveguide in FIGS. 5A-5B at initiation of actuation (t=tₒ) in a first direction;

FIG. 6B illustrates the actuatable optical waveguide in FIG. 6A after actuation (t=t₁) in the first direction;

FIG. 6C illustrates the actuatable optical waveguide in FIG. 6A after further actuation (t=t₂) in the first direction;

FIG. 6D illustrates actuation of the actuatable optical waveguide in FIG. 6A at initiation of actuation (t=t₃) in a second direction;

FIG. 6E illustrates the actuatable optical waveguide in FIG. 6D after actuation (t=t₄) in the second direction;

FIG. 6F illustrates the actuatable optical waveguide in FIG. 6D after further actuation (t=t₅) in the second direction;

FIG. 7 is a perspective view of an actuatable optical waveguide according to still another form of the present disclosure;

FIG. 8A illustrates actuation of the actuatable optical waveguide in FIG. 7 at initiation of actuation (t=tₒ) in a first direction;

FIG. 8B illustrates the actuatable optical waveguide in FIG. 8A after actuation (t=t₁) in the first direction;

FIG. 8C illustrates the actuatable optical waveguide in FIG. 8A after further actuation (t=t₂) in the first direction;

FIG. 9 is a flow chart for a method of manufacturing an actuatable optical waveguide according to the teachings of the present disclosure.

It should be noted that the figures set forth herein are intended to exemplify the general characteristics of the methods and devices among those of the present technology, for the purpose of the description of certain aspects. The figure may not precisely reflect the characteristics of any given aspect and are not necessarily intended to define or limit specific forms or variations within the scope of this technology.

### DETAILED DESCRIPTION

The present disclosure provides an actuatable optical waveguide capable configured to reversibly change shape in response to an external stimulus such that light can be directed through and exit the actuatable waveguide at different angles relative to or locations of an environment (space) where the actuatable optical waveguide is located. In some variations, the actuatable optical waveguide includes an optical fiber with a liquid crystal elastomer (LCE) outer cladding, a polymer core (i.e., a polymer material) disposed within the outer cladding (i.e., within the core of the outer cladding), and a shape memory polymer (SMP) layer disposed on an outer surface of the outer cladding such that the optical fiber is configured to reversibly change shape upon actuation of the SMP layer. The SMP is actuated from an external stimulus such as a thermal stimulus (i.e., heat), a light stimulus (e.g., LED, laser, etc.), and any combination thereof.

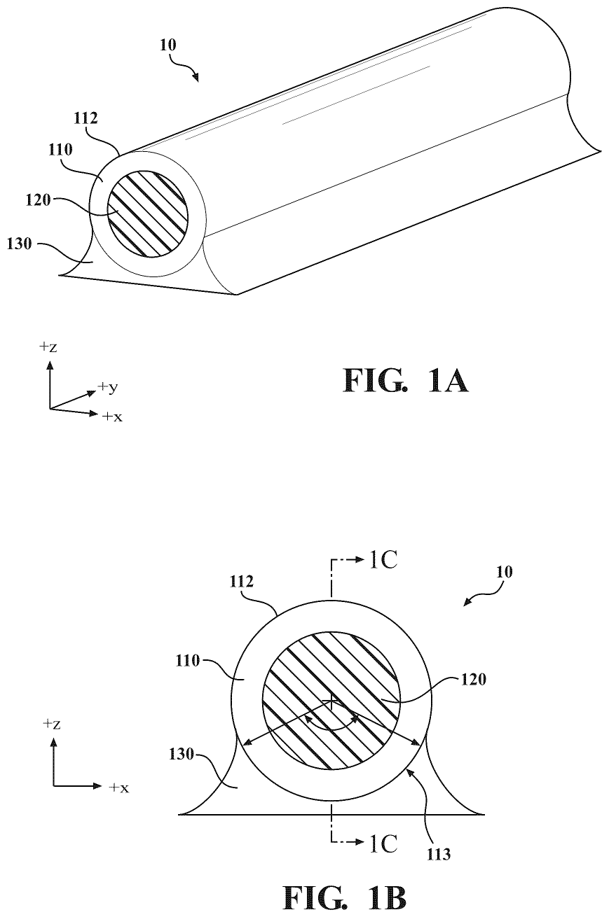

Referring to FIGS. 1A-1C, a perspective view, an end view, and a side view, respectively, of an actuatable optical waveguide 10 according to one form of the present disclosure is shown. The actuatable optical waveguide 10 includes an outer cladding 110, a core 120, and actuatable layer 130 disposed on an outer surface 112 of the outer cladding 110. It should be understood that the outer cladding 110 and the core 120 are configured for light to propagate through the core 120 and not escape or propagate through the outer cladding 110. In this manner, light enters and propagates from one end of the actuatable optical waveguide 10 and exits from an opposite end of the actuatable optical waveguide 10.

In at least one variation, the outer cladding 110 is formed from an LCE, i.e., the outer cladding 110 is an LCE outer cladding 110. It should be understood that an LCE, i.e., LCEs, are a class of soft stimuli responsive materials formed from stiff mesogens bound to an elastomeric network of flexible polymer chains. In some variations, the mesogens order and disorder in response to an external stimulus, e.g., heat, light, and/or mechanical deformation, which thereby allows the LCEs to undergo reversible phase transitions between the polydomain, monodomain, and isotropic states. The motion of the mesogens relative to the polymer network also enables reversible actuation in response to temperature or light.

In some variations, the core 120 is formed from a polymer, i.e., the core 120 is a polymer core 120. For example, in some variations the polymer core 120 is formed from polydimethylsiloxane (PDMS), polystyrene, and/or polymethylmethacrylate (PMMA). For example, in one variation the actuatable optical waveguide 10 includes a PDMS core 120.

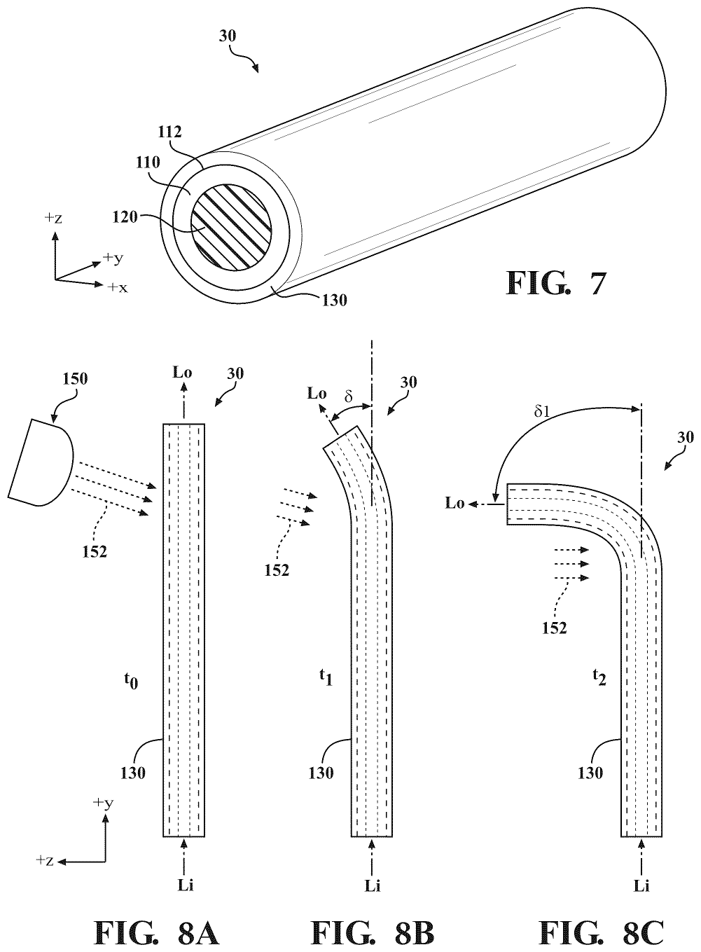

In at least one variation, the actuatable layer 130 is formed from an SMP, i.e., the actuatable layer 130 is an SMP actuatable layer 130. Examples of the SMP that form the actuatable layer 130 include a polytetrafluoroethylene (PFTE), polylactide (PLA), and ethylene-vinyl acetate (EVA), among others. In some variations, the actuatable layer 130 is disposed on a circumferential portion 113 (FIG. 1B) of the outer surface 112 and extends in a length direction (y-direction) of the outer cladding 110. In other variations the actuatable layer 130 is disposed on the entire circumference of the outer surface 112 (FIG. 7) and extends in a length direction (y-direction) of the outer cladding 110 as illustrated in FIG. 1D.

In some variations, the actuatable layer 130, and other actuatable layers disclosed herein, are in directed contact with the outer surface 112 of the outer cladding 110, while in other variations one or more layers (e.g., a coating) is disposed between the actuatable layer 130 and the outer surface of the outer cladding 110. And while the geometric shape in the x-z plane (FIG. 1B) of the actuatable layer 130 appears as a truncated triangle (with curved sides), it should be understood that the actuatable layer 130 can have other geometric shapes in the x-z plane shown in the figures.

As illustrated in FIGS. 1A-1C, the circumferential portion 113 of the outer surface 112 is less than the entire circumference of the outer surface 112. Stated differently, the actuatable layer 130 is disposed continuously along the length direction (y-direction) of the outer cladding 110, but extends along or covers a portion of the circumference of the outer cladding 110 that is less than 360 degrees. In some variations, the actuatable layer 130 covers or disposed over an angle ‘θ’ along the circumference of the outer surface 112 (FIG. 1B) that is less than or equal to 18°. For example, in at least one variation θ is less than 150°, e.g., less than 120°, less than 90° or less than 60°. In some variations the coverage of the circumference of the outer surface 112 by the actuatable layer 130 is between about 60° and about 90°, while in other variations the coverage of the circumference of the outer surface 112 by the actuatable layer 130 is between about 90° and about 120°. In still other variations the coverage of the circumference of the outer surface 112 by the actuatable layer 130 is between about 120° and about 150°, and in at least one variation the coverage of the circumference of the outer surface 112 by the actuatable layer 130 is between about 150° and about 180°.

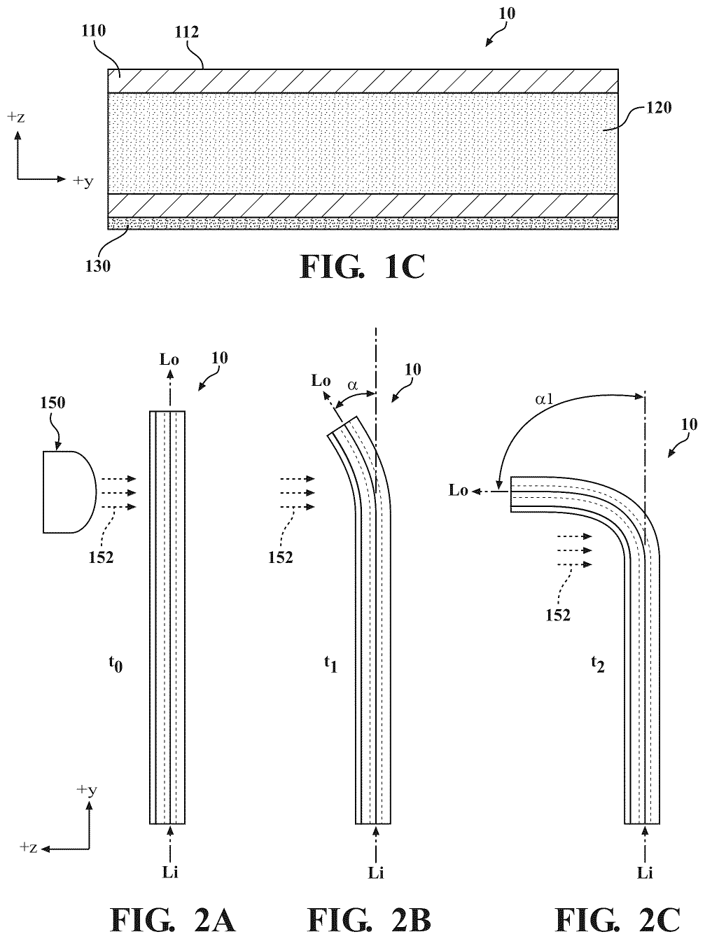

Referring to FIGS. 2A-2C, actuation of the actuatable optical waveguide 10 is illustrated. Particularly, FIG. 2A illustrates the actuatable optical waveguide 10 at time ‘tₒ’ with light ‘Lᵢ’ entering the core 120 and light ‘Lₒ’ exiting the core 120. An actuator device 150 has been activated, but actuation (e.g., bending) of the actuatable layer 130 has yet to occur such that the light Lo is propagating parallel to the y-axis shown in the figure. In some variations, the actuator device 150 can be a heat device that provides heat 152 to the actuatable layer 130 and/or a light source that provides or propagates light 152 to the actuatable layer 130.

FIG. 2B illustrates the actuatable optical waveguide 10 at time ‘t₁’ (t₁>tₒ) with actuation of the actuatable layer 130 via heat and/or light 152 having occurred. As such, the upper (+y direction) portion of the actuatable optical waveguide 10 has bent in the +z direction and the light Lₒ propagates at an angle ‘α’ (not equal to zero) relative to the y-axis shown in the figure. And FIG. 2C illustrates the actuatable optical waveguide 10 at time ‘t₂’ (t₂<t₁) with further (additional) actuation of the actuatable layer 130 via heat and/or light 152 such that the upper (+y direction) portion of the actuatable optical waveguide 10 is further bent in the +z direction and the light Lₒ propagates at an angle α1 relative to the y-axis (α1>α). In some variations, the angle α is greater than about 15° and less than about 120°, for example, greater than about 15° and less than about 30°, greater than about 30° and less than about 60°, greater than about 60° and less than about 90°, or greater than about 90° and less than about 120°. In addition, it should be understood that the angle α of the light Lₒ propagating relative to the y-axis shown in the figures can be controlled as a function of time of actuation by the heat and/or light 152 and/or intensity of the actuation by the heat and/or light 152.

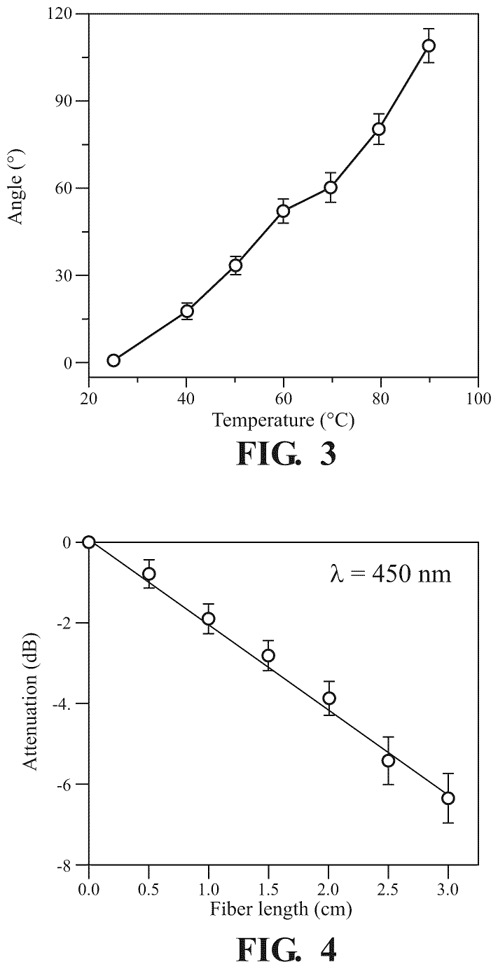

For example, and with reference to FIG. 3, the angle of bending (i.e., the angle α) by the actuatable optical waveguide 10 as a function of actuation temperature for the actuatable layer 130 is shown. That is, increasing the temperature of the actuatable layer 130 from about 25° C. to about 60° C. results in an angle α of about 52° and increasing the temperature of the actuatable layer 130 to about 82° C. results in an angle α of about 90°. In addition, the actuation/bending of the actuatable optical waveguide 10 is reversible, i.e., cooling the actuatable layer 130 to about 25° C. results in an angle α of about 0°. In this manner, the actuatable optical waveguide 10 provides for reversible propagation of light around corners.

Referring to FIG. 4, a graphical plot of attenuation as a function of fiber length for an actuatable optical waveguide 10 formed from an LCE outer cladding 110 and a 0.5 millimeter (mm) PDMS core 120 is shown. The attenuation was measured using a 450 nm laser source attached to one end of the actuatable optical waveguide 10 that was 4 centimeter (cm) long and measuring light intensity at the other end of the actuatable optical waveguide 10 after cutting 5 mm long segments therefrom repeatedly. Also the attenuation of the actuatable optical waveguide 10 was 2.2 dB cm⁻¹.

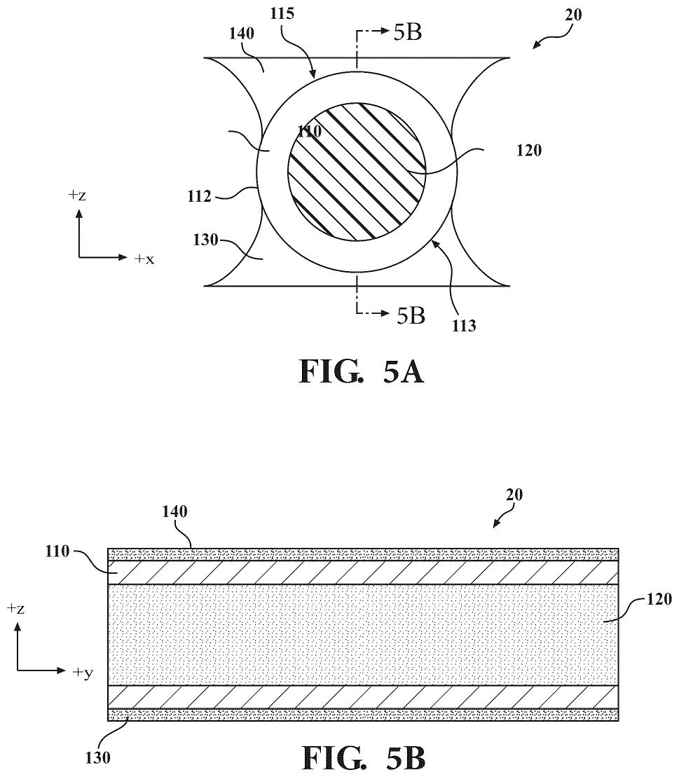

Referring now to FIGS. 5A-5B, an end view and a cross-sectional side view, respectively, of an actuatable optical waveguide 20 to another form of the present disclosure is shown. The actuatable optical waveguide 20 includes the outer cladding 110, the core 120, and the actuatable layer 130 disposed on the outer surface 112 of the outer cladding 110. In addition, the actuatable optical waveguide 20 includes another actuatable layer 140. Stated differently, the actuatable optical waveguide 20 includes a first actuatable layer 130 and a second actuatable layer 140 that is different than the first actuatable layer 130.

In some variations, the first actuatable layer 130 is disposed on a first circumferential portion 113 of the outer surface 112 and the second actuatable layer 140 is disposed on a second circumferential portion 115 of the outer surface 112 that is different than the first circumferential portion 113. And in such variations, the first actuatable layer 130 and the second actuatable layer 140 may or may or may not overlap each other circumferentially. For example, in some variations the first actuatable layer 130 and the second actuatable layer 140 are spaced circumferentially apart from each other as illustrated in FIG. 4A, while in other variations the first actuatable layer 130 and the second actuatable layer 140 partially overlap each other circumferentially (not shown). And in at least one variation, the first actuatable layer 130 and the second actuatable layer 140 circumferentially abut against each other along the length direction (y-direction) and do not circumferentially overlap each other (not shown). Also, in some variations, the first actuatable layer 130 and the second actuatable layer 140 are formed from the same SMP, while in other variations the first actuatable layer 130 and the second actuatable layer 140 are formed from different SMPs.

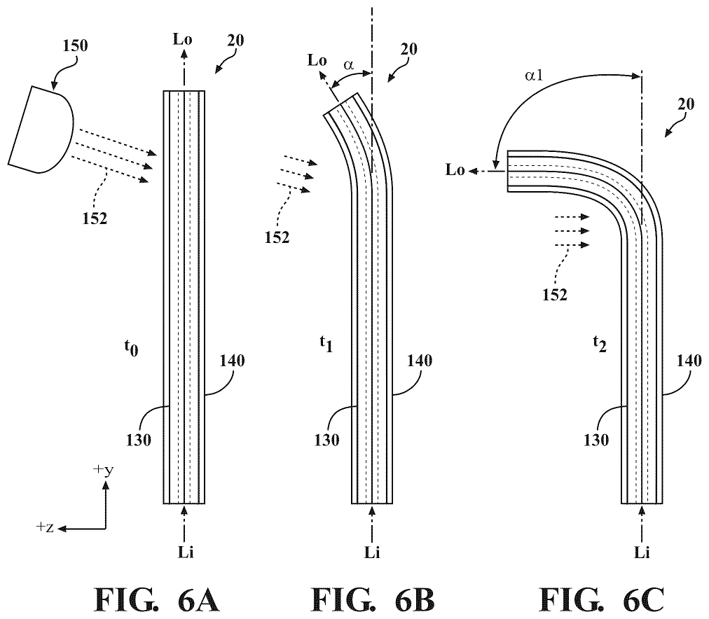

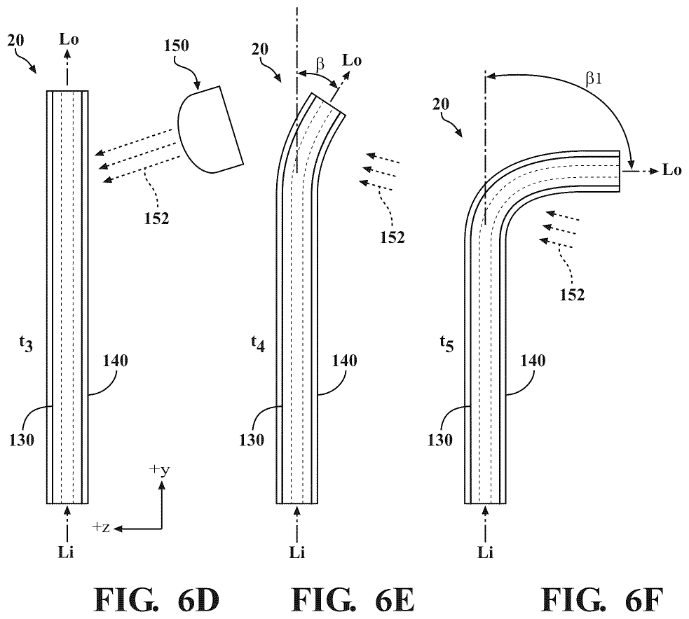

Referring to FIGS. 6A-6F, actuation of the actuatable optical waveguide 20 is illustrated. Particularly, FIGS. 6A-6C illustrate actuation of the actuatable layer 130 as discussed above with respect to FIGS. 2A-2C. That is, FIG. 6A illustrates the actuatable optical waveguide 20 at time ‘tₒ’ with light ‘Lᵢ’ entering the core 120 and light ‘Lₒ’ exiting the core 120 at the same angle, FIG. 6B illustrates the actuatable optical waveguide 10 at time ‘t₁’ (t₁>tₒ) with light Lᵢ entering the core 120 and light Lₒ exiting the core 120 at an angle ‘α’ (not equal to zero) relative to the y-axis shown in the figure, and FIG. 6C illustrates the actuatable optical waveguide 10 at time ‘t₂’ (t₂<t₁) with light Lᵢ entering the core 120 and light Lₒ exiting the core 120 at an angle α1 relative to the y-axis (α1>α). And with reference to FIGS. 6D-6F, actuation of the actuatable layer 140 is shown with FIG. 6D illustrating the actuatable optical waveguide 20 at time ‘t₃’ with light ‘Lᵢ’ entering the core 120 and light ‘Lₒ’ exiting the core 120 at the same angle. That is, the actuator device 150 has been activated, but actuation (e.g., bending) of the actuatable layer 140 has yet to occur such that the light Lo is propagating parallel to the y-axis shown in the figure.

FIG. 6E illustrates the actuatable optical waveguide 20 at time ‘t₄’ (t₄>t₃) with actuation of the actuatable layer 140 via heat and/or light 152 having occurred. As such, the upper (+y direction) portion of the actuatable optical waveguide 20 has bent in the-z direction and the light Lₒ propagates at an angle ‘β’ (not equal to zero) relative to the y-axis shown in the figure. And FIG. 6F illustrates the actuatable optical waveguide 20 at time ‘t₅’ (t₅<t₄) with further (additional) actuation of the actuatable layer 140 via heat and/or light 152 such that the upper (+y direction) portion of the actuatable optical waveguide 20 is further bent in the-z direction and the light Lₒ propagates at an angle β1 relative to the y-axis (β1>β). In some variations, the angle β is greater than about 15° and less than about 120°, for example, greater than about 15° and less than about 30°, greater than about 30° and less than about 60°, greater than about 60° and less than about 90°, or greater than about 90° and less than about 120°. In addition, it should be understood that the angle α of the light Lₒ propagating relative to the y-axis shown in the figures can be controlled as a function of time of actuation by the heat and/or light 152 and/or intensity of the actuation by the heat and/or light 152.

As noted above, the shape of the actuatable layer 130 and/or the shape of the actuatable layer 140 is/are not limited to a truncated triangle and partial coverage of the circumference of the outer surface 112 of the outer cladding 110 is not required. For example, and with reference to FIG. 7, a perspective view of an actuatable optical waveguide 30 according to still another form of the present disclosure is shown. The actuatable optical waveguide 30 includes the outer cladding 110, the core 120, and the actuatable layer 130 disposed circumferentially on the entire outer surface 112 of the outer cladding 110.

In addition, and as illustrated in FIGS. 8A-8C, actuation of one side (+z side shown in FIGS. 8A-8C) of the actuatable layer 130 results in bending of the actuatable optical waveguide 30. Particularly, FIG. 8A illustrates the actuatable optical waveguide 30 at time ‘tₒ’ with light ‘Lᵢ’ entering the core 120 and light ‘Lₒ’ exiting the core 120 at the same angle, FIG. 8B illustrates the actuatable optical waveguide 30 at time ‘t₁’ (t₁>tₒ) with light Lᵢ entering the core 120 and light Lₒ exiting the core 120 at an angle ‘δ’ (not equal to zero) relative to the y-axis shown in the figure, and FIG. 8C illustrates the actuatable optical waveguide 30 at time ‘t₂’ (t₂<t₁) with light Lᵢ entering the core 120 and light Lₒ exiting the core 120 at an angle δ1 relative to the y-axis (δ1>δ).

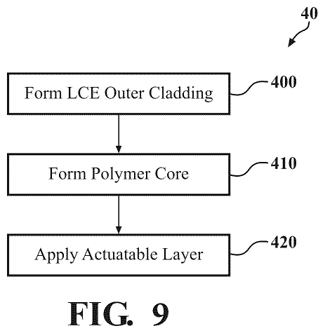

Referring now to FIG. 9, a flow chart for a method 40 of fabricating an actuatable optical waveguide according to the teachings of the present disclosure is shown. The method 40 includes forming an LCE outer cladding at 400, forming a polymer core within the LCE outer cladding at 410, and applying or forming an actuatable (e.g., SMP) layer at 420. In some variations, forming the LCE outer cladding at 400 includes co-axial spinning a LCE with a sacrificial liquid used to form an inner core. For example, LCE diacrylate mesogens and a flexible dithiol chain extender are used and react to from a linear LCE oligomer ink which serves as an outer shell fluid during the coaxial spinning. Also, water is selected as the inner core solution due to its inertness with LCE and ease of removal. In some variations, co-extrusion of the LCE ink and water through a coaxial nozzle, with subsequent removal of the water, forms the outer cladding. And exposure to UV light cures (i.e., UV-cured) the LCE outer cladding such that a mechanically robust hollow LCE fiber is provided. The outer diameter of the outer cladding can range from about 0.6 mm to about 1.6 mm and the inner diameter of the outer cladding can range from 0.2 mm to about 0.6 mm.

In some variations, forming the polymer core within the LCE outer cladding at 410 includes introducing a UV-curable PDMS precursor, containing thiol and vinyl functional groups, into the hollow core of the LCE outer cladding followed by UV curing of the PDMS. The presence of the thiol and vinyl groups in the PDMS precursor facilitates strong bonding between the PDMS core and the LCE outer cladding, thereby enhancing the durability of the actuatable optical waveguide during repeated bending.

In some variations, apply or forming the actuatable layer on the outer surface of the outer cladding includes dipping the outer cladding, with or without the polymer core, into an SMP ink and subsequently UV curing the SMP ink. And as illustrate above with respect to FIGS. 1A-1C, 5A-5B, and 7, the SMP ink can be used to form the actuatable layer on a single circumferential portion of the outer surface of the outer cladding, on two separate circumferential portions of the outer surface, and on the entirety of the outer surface. In addition, it should be understood the SMP ink can be used to form the actuatable layer on more than two separate circumferential portions of the outer surface of the outer cladding,.

In at least one variation, only a portion of length of an actuatable optical waveguide according to the teachings of the present disclosure has an actuatable layer applied thereto such that only a portion of the length can be actuated, i.e., only a portion of a length of an actuatable optical waveguide is configured to be actuated and bend as discussed above.

The preceding description is merely illustrative in nature and is in no way intended to limit the disclosure, its application, or uses. Work of the presently named inventors, to the extent it may be described in the background section, as well as aspects of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or. ” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple variations or forms having stated features is not intended to exclude other variations or forms having additional features, or other variations or forms incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one variation, or various variations means that a particular feature, structure, or characteristic described in connection with a form or variation, or particular system is included in at least one variation or form. The appearances of the phrase “in one variation” (or variations thereof) are not necessarily referring to the same variation or form. It should be also understood that the various method steps discussed herein do not have to be carried out in the same order as depicted, and not each method step is required in each variation or form.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. An actuatable optical waveguide comprising:
an optical fiber comprising:
a liquid crystal elastomer (LCE) outer cladding;
a polymer core disposed within the LCE outer cladding; and
a shape memory polymer (SMP) layer disposed on an outer surface of the LCE outer cladding such that the optical fiber is configured to reversibly change shape upon actuation of the SMP layer.

2. The actuatable optical waveguide according to claim 1, wherein the polymer core comprises polydimethylsiloxane (PDMS).

3. The actuatable optical waveguide according to claim 2, wherein the LCE outer cladding and polymer core is UV-cured.

4. The actuatable optical waveguide according to claim 1, wherein the SMP layer is UV-cured and disposed on a portion of the outer surface, the portion being less than an entirety of the outer surface.

5. The actuatable optical waveguide according to claim 4, wherein the SMP layer extends along a length direction of the LCE outer cladding and the portion of the outer surface is a circumferential portion of the outer surface.

6. The actuatable optical waveguide according to claim 5, wherein the optical fiber is configured to reversibly bend at an angle greater than or equal to 90°.

7. The actuatable optical waveguide according to claim 1, wherein the SMP layer is actuated by a stimulus selected from the group consisting of a light stimulus and a thermal stimulus.

8. The actuatable optical waveguide according to claim 1, wherein the SMP layer comprises a first SMP layer extending along a first portion of the outer surface and a second SMP layer extending along a second portion of the outer surface.

9. The actuatable optical waveguide according to claim 8, wherein the first SMP layer and the second SMP layer extend along a length direction of the LCE cladding of the outer surface, the first portion of the outer surface is a first circumferential portion of the outer surface and the second portion of the outer surface is a second circumferential portion of the outer surface different than the first circumferential portion.

10. The actuatable optical waveguide according to claim 9, wherein the first SMP layer is positioned circumferentially opposite the second SMP layer.

11. The actuatable optical waveguide according to claim 10, wherein the optical fiber is configured to bend at an angle greater than or equal to 90° in a first direction and at an angle greater than or equal to 90° in a second direction different than the first direction.

12. The actuatable optical waveguide according to claim 11, wherein the first direction is 180° from the second direction.

13. The actuatable optical waveguide according to claim 8, wherein a combined surface area of the first portion of the outer surface and the second portion of the outer surface is less than an entire surface area of the outer surface.

14. An actuatable optical waveguide comprising:
an optical fiber comprising:
a UV-cured liquid crystal elastomer (LCE) outer cladding;
a UV-cured polydimethylsiloxane (PDMS) core disposed within the UV-cured LCE outer cladding; and
a UV-cured shape memory polymer (SMP) layer disposed on an outer surface of the UV-cured LCE outer cladding such that the optical fiber is configured to reversibly change shape upon actuation of the UV-cured SMP layer.

15. The actuatable optical waveguide according to claim 14, wherein the UV-cured SMP layer is disposed on a portion of the outer surface, the portion being less than an entirety of the outer surface.

16. The actuatable optical waveguide according to claim 15, wherein the UV-cured SMP layer extends along a length direction of the LCE outer cladding and the portion of the outer surface is a circumferential portion of the outer surface.

17. The actuatable optical waveguide according to claim 16, wherein the UV-cured SMP layer is a first UV-cured SMP layer and a second UV-cured SMP layer, the circumferential portion of the outer surface is a first circumferential portion and a second circumferential portion, and the first UV-cured SMP layer is disposed on the first circumferential portion and the second UV-cured SMP layer is disposed on the second circumferential portion.

18. The actuatable optical waveguide according to claim 17, wherein the optical fiber is configured to bend at an angle greater than or equal to 90° in a first direction and at an angle greater than or equal to 90° in a second direction different than the first direction.

19. An actuatable optical waveguide comprising:
an optical fiber comprising:
a UV-cured liquid crystal elastomer (LCE) outer cladding;
a UV-cured polydimethylsiloxane (PDMS) core disposed within the UV-cured LCE outer cladding; and
a UV-cured shape memory polymer (SMP) layer disposed on a portion of an outer surface of the UV-cured LCE outer cladding such that the optical fiber is configured to reversibly change shape upon actuation of the UV-cured SMP layer, the portion of the outer surface being less than an entirety of the outer surface.

20. The actuatable optical waveguide according to claim 19, wherein the UV-cured SMP layer extends along a length direction of the LCE outer cladding and the portion of the outer surface is a circumferential portion of the outer surface.
